(19) United States
(12) Patent Application Publication
(10) Pub. No.: US 2025/0117631 A1
(43) Pub. Date: Apr. 10, 2025

(54) System and Method for Task-dependent Safeguarding of Generative Artificial Intelligence (AI) Output

(71) Applicant: Microsoft Technology Licensing, LLC, Redmond, WA (US)

(72) Inventors: Hadas Bitran, Ramat Hasharon (IL); Uri Einav, Yuvalim (IL); Rachel Wities, Givat Shmuel (IL); Yochai Daniel Lehman, Beit Gamliel (IL); Aviram Fireberger, Kibbutz Karmia (IL); Aaron Toby Bornstein, Zikhron Yaakov (IL); Yehudit Keren Meged, Petah Tikva (IL); Tal Baumel, Tel-Aviv (IL)

(21) Appl. No.: 18/482,438

(22) Filed: Oct. 6, 2023

(51) Int. Cl. G06N 3/0475

(52) U.S. Cl. CPC G06N 3/0475

(57) ABSTRACT

A method, computer program product, and computing system for processing target content generated by processing source content using a generative artificial intelligence (AI) model, where the generative AI model performs a task using the source content to generate the target content. An ontological concept is extracted from the source content using a natural language processing (NLP) engine. An ontological concept is extracted from the target content using the NLP engine. An ontological concept comparison score is generated by comparing the ontological concept from the source content and the ontological concept from the target content based upon, at least in part, the task performed using the source content to generate the target content. An issue is identified in the target content based upon, the ontological concept comparison score and the task performed using the source content to generate the target content.

### BACKGROUND

Many information domains are relying on advances in generative artificial intelligence (AI) to address questions or to perform tasks. However, in some of these information domains, such as healthcare, the answers or resulting content generated by a generative AI model as-is is insufficient. For example, in the healthcare domain, clinical and medical texts such as admission notes, radiology reports, progress notes, etc. are typically written by clinical professionals. In the case where generative AI is used for translating the text, for creating a version in simpler/laymen language, or summarizing the text, existing approaches are unable to validate the accuracy of the result, ensure that nothing important was left out from the input (omission), and/or that no content was fabricated (hallucination).

### BRIEF DESCRIPTION OF THE DRAWINGS

FIG. 1 is a flow chart of one implementation of a generative AI safeguarding process;

FIG. 2 is a diagrammatic view of the generative AI safeguarding process of FIG. 1;

FIG. 3 is a diagrammatic view of an ontological graph according to example implementations of the generative AI safeguarding process of FIG. 1; and

FIG. 4 is a diagrammatic view of computer system and a generative AI safeguarding process coupled to a distributed computing network.

Like reference symbols in the various drawings indicate like elements.

### DETAILED DESCRIPTION OF THE PREFERRED EMBODIMENTS

Implementations of the present disclosure provide a process for applying safeguards to document or content translation, simplification, and/or summarization tasks performed by a generative AI model. The process leverages multi-lingual information extraction performed on the source content (i.e., the original content or document) and the target content (i.e., the resulting content produced by the generative AI model), applies task-specific rules that rely on standard ontologies (potentially hierarchical) and on a taxonomy of entities for performing validation on the target content for hallucination/omission detection according to a task-specific set of rules.

For example, implementations of the present disclosure allow for unsupervised and explainable processing of a generative AI model's content for a particular task. For example, generative AI models are known for their ability to make unique connections to generate results to input requests. However, these results are generally difficult to constrain without significant intervention and are not explainable. In other words, a generative AI model is generally unable to describe “why” it produced the content it did for a given input request. Accordingly, implementations of the present disclosure use the ontological concepts and their relationships to determine whether there are any issues with the output of a generative AI model for a given task.

Specifically, the process includes processing target content generated by a generative AI model, where the generative AI model performs a task using source content to generate the target content. A list of ontological concepts is extracted from the source content using a natural language processing (NLP) engine and a list of ontological concepts is separately extracted from the target content using the NLP engine. An ontological concept comparison score is generated by comparing the ontological concepts from the source content and the ontological concepts from the target content based upon, at least in part, the task performed using the source content to generate the target content. With the ontological concept comparison scores, any issues in the target content are identified for the given task.

The details of one or more implementations are set forth in the accompanying drawings and the description below. Other features and advantages will become apparent from the description, the drawings, and the claims.

### The Generative AI Safeguarding Process:

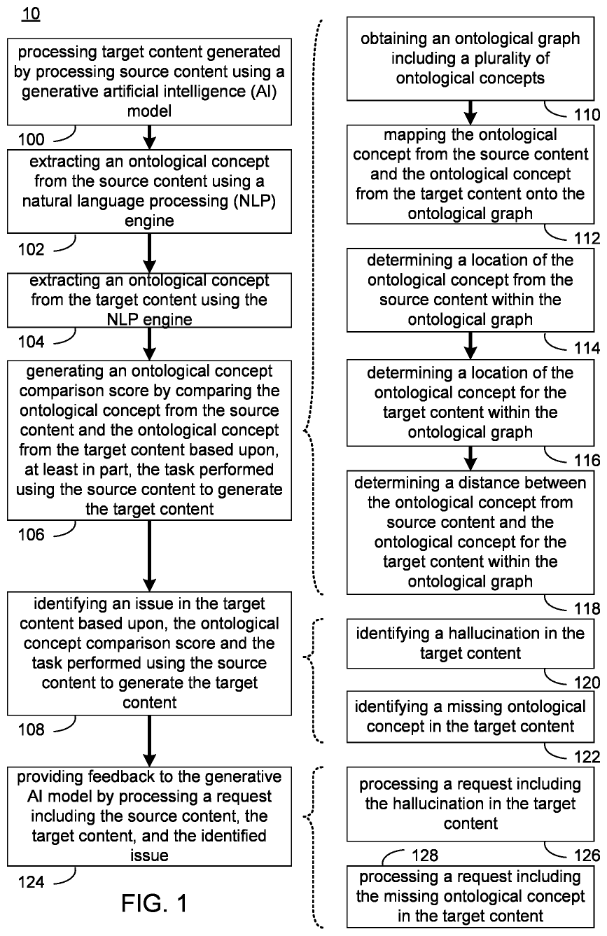

Referring to FIGS. 1-4, generative AI safeguarding process 10 processes 100 target content generated by processing source content using a generative artificial intelligence (AI) model, wherein the generative AI model performs a task using the source content to generate the target content. An ontological concept is extracted 102 from the source content using a natural language processing (NLP) engine. An ontological concept is extracted 104 from the target content using the NLP engine. An ontological concept comparison score is generated 106 by comparing the ontological concept from the source content and the ontological concept from the target content based upon, at least in part, the task performed using the source content to generate the target content. An issue is identified 108 in the target content based upon, the ontological concept comparison score and the task performed using the source content to generate the target content.

In some implementations, generative AI safeguarding process 10 processes 100 target content generated by processing source content using a generative artificial intelligence (AI) model. A generative AI model uses neural networks to identify patterns and structures within a data set to perform a particular task (e.g., translate source content from one language into another, summarize the source content, simplify the source content, etc.). In some implementations, a generative AI model (e.g., generative AI model 200) is configured to receive natural language prompts and/or example entries and/or contextual information concerning a request to generate a response. In some implementations, the generative AI model includes a Large Language Model (LLM). A LLM (e.g., Bing® Chat from Microsoft®, GPT-4 from OpenAIR, and Bard from Google®) is a language model consisting of a neural network with many parameters (typically billions of weights or more), trained on large quantities of unlabeled text using self-supervised learning or semi-supervised learning. Though trained on simple tasks along the lines of predicting the next word in a sentence, LLMs with sufficient training and parameter counts capture the syntax and semantics of human language. In addition, LLMs demonstrate considerable general knowledge and are able to “memorize” large quantities of facts during training.

In some implementations, the generative AI model performs a task using the source content to generate the target content. For example, generative AI model 200 is provided with source content (e.g., source content 202) and a task (e.g., task 204) for processing. In one example, source content 202 is a document (e.g., text, mixed media, etc.). In a domain-specific example, source content 202 includes clinical notes from a medial encounter, a medical report, an electronic health record, etc. In another example, source content is audio information, video information, or other multi-media content. For these examples, generative AI model 200 is a multi-modal AI model configured to process multiple types of content. Accordingly, various types of source content are processed by generative AI model 200 to perform various tasks.

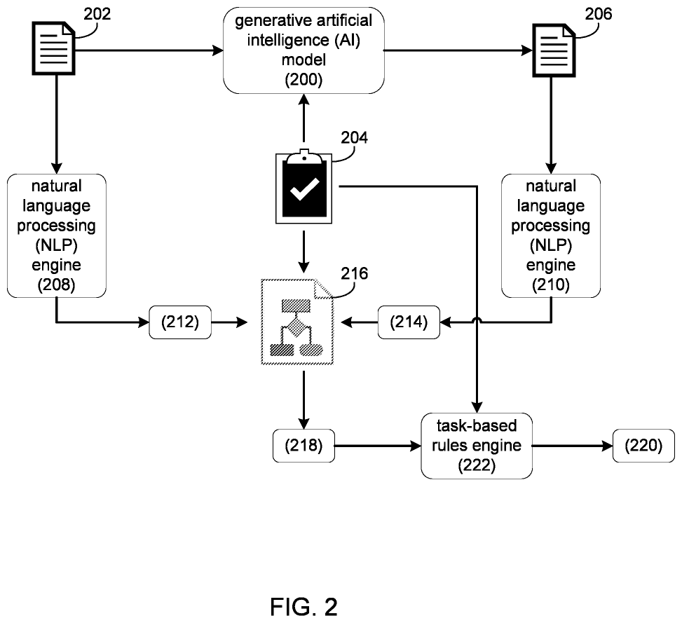

In some implementations, task 204 provides constraints for directing generative AI model 200 to generate target content (e.g., target content 206). In one example, task 204 includes a request to translate source content 202 from one language (e.g., a source language) into another language (e.g., a target language). In another example, task 204 includes a request to simplify source content 202 into more easily understandable terms and phrases (i.e., from domain-specific jargon and terms of art to more general descriptions). In another example, task 204 includes a request to summarize source content 202 into a summary of limited length (i.e., a maximum word or sentence count) and/or a generic description of specific details from source content 202. As shown in FIG. 2, source content 202 is processed by generative AI model 200 with task 204 to generate target content 206.

In one example, suppose that source content 202 includes the following transcription of an encounter between a medical professional and a patient:
[doctor] next patient's last name is first name XXX date of birth XXX hey XXX
[patient] hi how are you doing
[doctor] I'm good how are you feeling man what's going on
[patient] i don't know just like a pain in my chest and then shortness of breath nausea
[doctor] when did this start
[patient] yesterday afternoon it was really bad but today it's not as bad
[doctor] okay so the symptoms got much worse before you came to see me uh
[patient] yeah
[doctor] what number would you give your pain right now zero to ten
[patient] nine
[doctor] okay and where does it hurt at
[patient] right here
[doctor] all over the place uh any fevers or chills
[patient] no
[doctor] coughing up anything for you bringing up stuff from the lungs
[patient] no
[doctor] have you ever had a pulmonary embolism before
[patient] yes sir
[doctor] when was that done remind me
[patient] two thousand sixteen
[doctor] okay and you're still having some shortness of breath with exertion too
[patient] mm-hmm
[doctor] any leg pain or swelling at all
[patient] no sir
[doctor] okay let me take a listen to you let's get an ekg real quick make sure everything looks okay there and then I'll come back in after we get that done okay
[patient] alright thank you
[doctor] physical exam he appears fatigued. heart rate is regular rhythm without murmurs gallops or rubs. lungs clear to auscultation bilaterally. assessment and plan under chest pain due to atypical presentation likely secondary to pericarditis however given his history of pe, we'll obtain further evaluation by cardiology. if symptoms worsen or change in nature may need cardiac work-up including stress test et cetera. patient understands and agrees to go forward with this plan of care. meanwhile advised supportive care measures reviewed signs symptoms worsening condition including severe chest pain, shortness of breath fever or chills. should these occur should be evaluated immediately prior to seeing us. patient has been instructed on worrisome signs and symptoms to monitor for such as severe chest pain or other concerning complications.

Now suppose that generative AI model 200 processes source content 202 and task 204, where task 204 is a request to summarize the medical transcription. An example of target content 206 is provided below:
The patient, whose last name and date of birth are not provided, visited the doctor with complaints of chest pain, shortness of breath, and nausea. These symptoms started yesterday afternoon, worsened briefly, and are currently at a pain level of nine, localized in the chest. The patient denies fevers, chills, coughing up anything from the lungs but has a history of a pulmonary embolism. The doctor conducted a physical examination, which revealed a regular heart rate and clear lungs. The assessment suggests atypical chest pain and recommends further evaluation by cardiology. The patient was advised that the cause of these issues is likely due to malnutrition. The patient was advised on monitoring for worsening symptoms and to seek immediate evaluation in case of severe chest pain or other concerning complications.

In some implementations, generative AI safeguarding process 10 extracts 102 an ontological concept from the source content using a natural language processing (NLP) engine. An ontology is a formal and structured representation of knowledge that defines the concepts, relationships, and entities within a specific domain or subject area. It serves as a model or framework for organizing information in a way that makes it understandable and machine-readable. Ontologies are commonly used in fields such as computer science, artificial intelligence, information science, and philosophy to capture and formalize knowledge in a standardized format.

Ontological concepts refer to the fundamental elements within an ontology. These are the building blocks that represent the essential ideas, categories, or entities related to a particular domain. Ontological concepts include things like objects, attributes, relationships, and classes. They help define the vocabulary used to describe and understand the domain, and they provide a structured way to categorize and relate information within that domain. Ontological concepts are crucial for knowledge representation, data integration, and reasoning in various applications, including semantic web technologies, data modeling, and knowledge-based systems.

In some implementations, extracting 104 an ontological concept from source content 202 includes processing source content 202 with a natural language processing (NLP) engine (e.g., NLP engine 208). A Natural Language Processing (NLP) engine is a type of software or AI system designed to understand, interpret, and generate human language. NLP engines are used in a wide range of applications, including chatbots, virtual assistants, sentiment analysis for social media monitoring, language translation, and information retrieval. They play a significant role in making human-computer interactions more natural and efficient by bridging the gap between human language and machine understanding. Example functions of NLP engine 208 include text understanding (i.e., tokenization (breaking text into words or phrases), part-of-speech tagging (identifying nouns, verbs, etc.)), and syntactic parsing (analyzing sentence structure) to analyze and interpret text to extract meaning; semantic analysis (i.e., going beyond basic text understanding to grasp the context and meaning of words and sentences); named entity recognition, identifying sensitive content, etc. In some implementations, NLP engine 208 compares each word or term from source content 202 to an ontology and extracts 102 each corresponding word or term from the ontology that is present in source content 202. As shown in the example of FIG. 2, generative AI safeguarding process 10 extracts 104 ontological concept 212. In some implementations, extracting 104 an ontological concept includes extracting a plurality of ontological concepts corresponding to any number of ontologies.

In some implementations, various ontologies may have unique ontological concepts. For example, in the healthcare domain, a clinical ontology may include various ontological concepts corresponding to clinical terms. Returning to the above example where source content 202 is a medical transcription and target content 206 is a summarization, suppose that NLP engine 208 is associated with (i.e., accesses or otherwise references) a healthcare ontology. In this example, generative AI safeguarding process 10 extracts 102 a plurality of ontological concepts from source content 202 concerning healthcare (e.g., pain, chest, shortness, breath, nausea, bad, fever, chills, lungs, pulmonary embolism, leg, swelling, fatigued, etc.). As will be discussed in greater detail below, generative AI safeguarding process 10 uses these ontological concepts extracted from source content 202 to determine whether there are any issues in target content 206 based on task 204 (e.g., omitted terms, hallucinated terms, etc.).

In some implementations, generative AI safeguarding process 10 extracts 104 an ontological concept from the target content using the NLP engine. In some implementations, NLP engine 210 compares each word or term from target content 206 to an ontology and extracts 104 each corresponding word or term from the ontology that is present in target content 206. As shown in the example of FIG. 2, generative AI safeguarding process 10 extracts 104 ontological concept 214 from target content 206. As with ontological concept 212 extracted by generative AI safeguarding process 10 from source content 202, generative AI safeguarding process 10 uses the presence or absence of ontological concepts 212, 214 in source content 202 and target content 206 to determine whether there are issues with target content 206 generated by generative AI model 200. In this manner and as will be discussed in greater detail below, generative AI safeguarding process 10 allows for unsupervised and explainable assessment of the results of generative AI model 200.

In some implementations, generative AI safeguarding process 10 generates 106 an ontological concept comparison score by comparing the ontological concept from the source content and the ontological concept from the target content based upon, at least in part, the task performed using the source content to generate the target content. An ontological concept comparison score is a numerical relationship between entities.

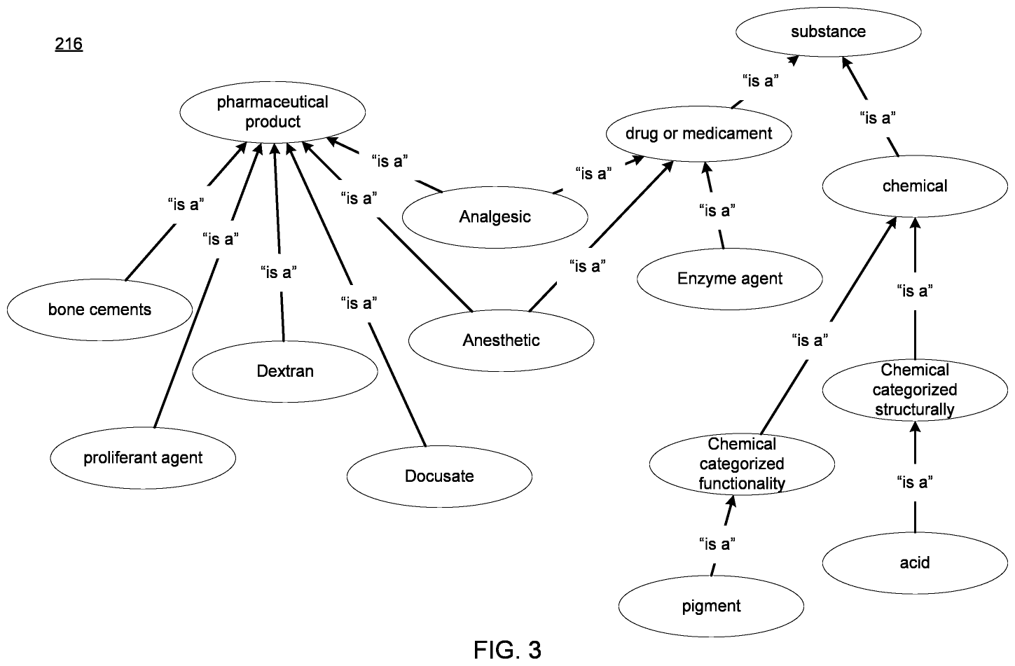

In some implementations, generating 106 the ontological concept comparison score includes: obtaining 110 an ontological graph including a plurality of ontological concepts; and mapping 112 the ontological concept from the source content and the ontological concept from the target content onto the ontological graph. For example and referring also to FIG. 3, generative AI safeguarding process 10 obtains 110 an ontological graph (e.g., ontological graph 216) by accessing an existing ontology (e.g., SNOMED-CT or MESH are examples of widely available clinical ontologies) or by generating an ontology. In one example, generative AI safeguarding process 10 accesses a database of ontologies associated with various tasks that are performed by generative AI model 200. In some implementations, ontological graph 216 is a node graph formed of nodes and edges where the nodes define ontological concepts and the edges form links that define relationships between respective ontological concepts. In the example of FIG. 3, “bone cements” are an ontological concept that “is a” pharmaceutical product. As shown in the example ontological graph of FIG. 3, the “pharmaceutical product” ontological concept is a genus for various species (e.g., “bone cements”; “Dextran”; “Anesthetic”; “Analgesic”; etc.). Accordingly, ontological graph 216 is shown in a hierarchical form. As will be discussed in greater detail below, the number of nodes that separate two linked nodes defines hierarchical levels and relative hierarchical distance. Accordingly, the relative distances in ontological graph 216 generally represents the “strength” of the relationship between various ontological concepts.

In response to obtaining 106 the ontological graph, generative AI safeguarding process 10 compares the extracted ontological concepts and maps 112 them to the plurality of ontological concepts of the ontological graph. In some implementations, the mapping 112 of ontological concept 212 extracted from source content 202 and ontological concept 214 from target content 206 includes comparing ontological concept 214 from source content 202 and ontological concept 214 from target content 206 to each ontological concept of ontological graph 216. As will be discussed in greater detail below, generative AI safeguarding process 10 determines whether each ontological concept from source content 202 and each ontological concept from target content 206 is mappable to the plurality of ontological concepts of ontological graph 216. In some implementations, the degree of mapping is user-defined. In one example, generative AI safeguarding process 10 may require an equivalent relationship between ontological concept 212 and/or ontological concept 214 and the respective ontological concepts of ontological graph 216. In another example, generative AI safeguarding process 10 may provide a threshold degree of matching required between ontological concept 212 and/or ontological concept 214 and the respective ontological concepts of ontological graph 216. In this manner, generative AI safeguarding process 10 allows for varying degrees of matching between extracted ontological concepts from source content 202 and target content 206.

In some implementations, generating 106 the ontological concept comparison score includes: determining 114 a location of the ontological concept from the source content within the ontological graph; determining 116 a location of the ontological concept for the target content within the ontological graph; and determining 118 a distance and a relationship type between the ontological concept from source content and the ontological concept for the target content within the ontological graph. For example, as ontological graph 216 describes the relationship between ontological concepts based on their distance and position relative to one another, generative AI safeguarding process 10 uses the location of ontological concept 212 from source content 202 and ontological concept 214 from target content 206 to determine the ontological concept comparison score. In some implementations, generative AI safeguarding process 10 determines 114 the location of ontological concept 212 as a relative position within ontological graph 216 and determines 116 the location of ontological concept 214 as a relative position within ontological graph 216. In some implementations, generative AI safeguarding process 10 determines 118 a distance between ontological concept 212 and ontological concept 214 as a numerical value. In one example, generative AI safeguarding process 10 determines the shortest distance between ontological concept 212 and ontological concept 214. In this example, the distance is the number of “edges” in ontological graph 216 between ontological concept 212 and ontological concept 214. In some implementations, generative AI safeguarding process 10 determines a relationship type between ontological concept 212 and ontological concept 214. Examples of relationship types include “parent-child” or “is-a”, where one ontological concept is an example of or “child of” of another ontological concept; “contributes to” where one ontological concept causes or leads to another ontological concept; “opposite of” where one ontological concept is the opposite of another ontological concept; and “equivalent to” where ontological concepts are synonymous. In some implementations, the relationship type defines the “edges” of ontological graph 216 and provides a particular weighting or distance for a given edge. In one example, the relationship type “is a” has a different distance value than the relationship “contributes to”. In this example, the distance values are default values, user-defined, or algorithmically defined by generative AI safeguarding process 10. In another example, a “medical distance” is defined between ontological concepts of a clinical ontology where the medical distance includes medical relationships that affect how clinical ontological concepts are related.

In some implementations and as shown in FIG. 2, generative AI safeguarding process 10 uses ontology graph 300 and the distance between the location of ontological concept 212 and the location of ontological concept 214 to determine the ontological concept comparison score (e.g., ontological concept comparison score 218). In one example, ontological concept comparison score 218 is closer to zero when ontological concept 212 and ontological concept 214 are more similar and greater when ontological concept 212 and ontological concept 214 are less similar. In another example, ontological concept comparison score 218 is greater when ontological concept 212 and ontological concept 214 are more similar and is less when ontological concept 212 and ontological concept 214 are less similar.

In some implementations, the ontological concept comparison score includes one or more of: an equivalent relationship between the ontological concept from the source content and the ontological concept from the target content; and a parent-child relationship between the ontological concept from the source content and the ontological concept from the target content. In some implementations, ontological concept comparison score 218 includes various predefined scores indicative of the type of relationship between ontological concept 212 and ontological concept 214. In one example, ontological concept comparison score 218 indicates that ontological concept 212 from source content 202 is an equivalent of ontological concept 214 from target content 206. In another example, ontological concept comparison score 218 indicates a parent-child relationship between ontological concept 212 from source content 202 and ontological concept 214 from target content 206. For example, suppose ontological concept 212 from source content 202 is “pigment” and that ontological concept 214 from target content 206 is “chemical”. In this example, ontological concept 214 is a parent of ontological concept 212. Accordingly, generative AI safeguarding process 10 generates 106 ontological concept comparison score 218 as indicative of a parent-child relationship.

In some implementations, generating 106 the ontological concept comparison score includes generating the ontological concept comparison score for target content 206 generally as an aggregate for each ontological concept. In one example, generative AI safeguarding process 10 generates a recall ontological concept comparison score for a particular task (e.g., simplification) as shown below in Equation 1:

$${recall}_{simplification} = \frac{\vert \begin{matrix}{source\_concepts}_{equivalent \_ relationship} ⋃ \\ {source\_concepts}_{parent \_ child \_ match ( n )}\end{matrix} \vert}{\vert source\_concepts \vert} \qquad ( 1 )$$

In this example, the variable “source_concepts_{equivalent_relationship}” represents the number of ontological concepts from source content 202 that are equivalents of ontological concepts from target content 206. The variable “source_concepts_{parent_child_match(n)}” represents the number of ontological concepts from source content 202 within the maximal acceptable depth of the parent-child relationship from ontological concepts from target content 206, where “n” is the maximal acceptable depth. The variable “source_concepts” represents the number of ontological concepts from source content 202.

In another example, generative AI safeguarding process 10 generates a recall ontological comparison score for a different task (e.g., translation) as show below in Equation 2:

$${recall}_{t r a n s l a t i o n} = \frac{\vert {source\_concepts}_{equivalent \_ relationship} \vert}{\vert source\_concepts \vert} \qquad ( 2 )$$

In some implementations, generative AI safeguarding process 10 identifies 108 an issue in the target content based upon, the ontological concept comparison score and the task performed using the source content to generate the target content. For example, generative AI safeguarding process 10 uses ontological concept comparison score 218 and task 204 to identify 108 an issue (e.g., issue 220) in target content 206. In one example, generative AI safeguarding process 10 uses a task-based rules engine (e.g., task-based rules engine 222) to identify an issue (e.g., issue) in target content 206 based upon, at least in part, ontological concept comparison score 218 and task 204. In some implementations, task-based rules engine 222 has a plurality of rule sets that define issues for various tasks.

For example and returning to the above examples of Equations 1-2, where the recall for the task of simplification includes target concepts that are within a maximal depth of acceptable parent-child relationship in addition to being an exact match (e.g., an equivalent relationship). In this example, the recall for simplification tolerates ontological concepts in target content 206 that are within the threshold maximal acceptable depth level of ontological concepts in source content 202 (i.e., the variable “n” in Equation 1). Continuing with this example, task-based rules engine 222 has a rule set that defines a threshold recall level for the simplification task. Accordingly, if the recall value as defined in ontological concept comparison score is below the threshold recall level for the simplification task, generative AI safeguarding process 10 identifies 108 an issue in target content 206.

In the example of FIG. 2, task-based rules engine 222 has a rule set that defines a threshold recall level for the translation task. In this example, because the level of accuracy required for translation is higher than that of the task of simplification, the recall translation score is only a factor of the number of ontological concepts from target content 206 that exactly match ontological concepts from source content 202. In some implementations, if the recall value as defined in ontological concept comparison score is below the threshold recall level for the translation task, generative AI safeguarding process 10 identifies 108 an issue in target content 206.

In some implementations, identifying 108 the issue in the target content includes one or more of: identifying 120 a hallucination in the target content; and identifying 122 a missing ontological concept in the target content. In one example, task-based rules engine 222 identifies a “hallucination” in target content 206 (i.e., an ontological concept that is fabricated by generative AI model 200) when there is not a corresponding ontological concept in source content 202. Returning to the above example where source content 202 is a medical transcription and target content 206 is a summarization of the medical transcription. In this example, suppose target content 206 includes the sentence “The patient was advised that the cause of these issues is likely due to malnutrition.” Now suppose that no ontological concepts concerning “malnutrition” are extracted from source content 202. Accordingly, generative AI safeguarding process 10 identifies a hallucination in target content 206 as the description of malnutrition has no basis in the ontological concepts of source content 202. In this manner, generative AI safeguarding process 10 is able to identify 108 issues automatically without supervision for a particular task by identifying 120 the hallucination.

In another example, task-based rules engine 222 identifies a missing ontological concept from target content 206 (i.e., an ontological concept that is generated in target content 206 by generative AI model 200) when there is a corresponding ontological concept in source content 202. Returning to the above example where source content 202 is a medical transcription and target content 206 is a summarization of the medical transcription. In this example, suppose source content 202 includes the sentence “assessment and plan under chest pain due to atypical presentation likely secondary to pericarditis however given his history of pe, we'll obtain further evaluation by cardiology.” Now suppose that no ontological concepts concerning “pericarditis” are extracted from target content 206. Accordingly, generative AI safeguarding process 10 identifies a missing ontological concept in target content 206 as the description of pericarditis is not found in the ontological concepts of target content 206. In this manner, generative AI safeguarding process 10 is able to identify 108 issues automatically without supervision for a particular task by identifying 122 ontological concepts missing from target content 206.

In some implementations, generative AI safeguarding process 10 provides 124 feedback to the generative AI model by processing a request including the source content, the target content, and the identified issue. Since generative AI safeguarding process 10 provides explainable results that can point exactly which ontological concepts in the target/source are missing/hallucinated, generative AI safeguarding process 10 can use this information to improve or fix a generated response by generative AI model 200.

In some implementations, providing 124 feedback to the generative AI model includes one or more of: processing 126 a request including the source content, the target content, and the hallucination in the target content; and processing 128 a request including the source content, the target content, and the missing ontological concept in the target content. For example, to address limitations in the output of generative AI model 200, generative AI safeguarding process 10 provides a new request to generative AI model 200 with source content 200, task 204, and the identified hallucination in target content 206. Continuing with the above example where generative AI safeguarding process 10 identifies 120 a hallucination in target content 206 in the form of “The patient was advised that the cause of these issues is likely due to malnutrition”, generative AI safeguarding process 10 provides 124 feedback to generative AI model 200 by processing 126 a request including source content 202, task 204, target content 206, and a description of the hallucination such that generative AI model 200 is “informed” that the hallucination is a hallucination that is an issue (e.g., issue 220) for task 204.

Continuing with the above example where generative AI safeguarding process 10 identifies 122 a missing ontological concept in target content 206 in the form of “pericarditis”, generative AI safeguarding process 10 provides 124 feedback to generative AI model 200 by processing 128 a request including source content 202, task 204, target content 206, and a description of the missing ontological concept such that generative AI model 200 is “informed” that the missing ontological concept is an issue (e.g., issue 220) for task 204.

### System Overview

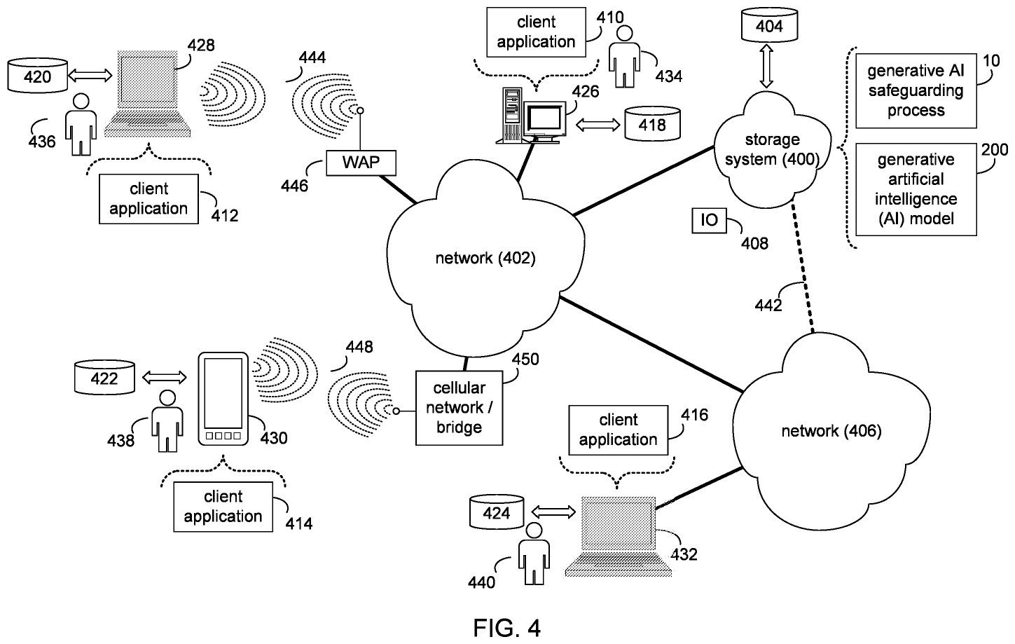

Referring to FIG. 4, a generative AI safeguarding process 10 is shown to reside on and is executed by storage system 400, which is connected to network 402 (e.g., the Internet or a local area network). Examples of storage system 400 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 400 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of generative AI safeguarding process 10, which are stored on storage device 404 included within storage system 400, are executed by one or more processors (not shown) and one or more memory architectures (not shown) included within storage system 400. Storage device 404 may include: a hard disk drive; an optical drive; a RAID device; a random-access memory (RAM); a read-only memory (ROM); and all forms of flash memory storage devices. Additionally or alternatively, some portions of the instruction sets and subroutines of generative AI safeguarding process 10 are stored on storage devices (and/or executed by processors and memory architectures) that are external to storage system 400.

In some implementations, network 402 is connected to one or more secondary networks (e.g., network 406), examples of which include: a local area network; a wide area network; or an intranet.

Various input/output (IO) requests (e.g., IO request 408) are sent from client applications 410, 412, 414, 416 to storage system 400. Examples of IO request 408 include data write requests (e.g., a request that content be written to storage system 400) and data read requests (e.g., a request that content be read from storage system 400).

The instruction sets and subroutines of client applications 410, 412, 414, 416, which may be stored on storage devices 418, 420, 422, 424 (respectively) coupled to client electronic devices 426, 428, 430, 432 (respectively), may be executed by one or more processors (not shown) and one or more memory architectures (not shown) incorporated into client electronic devices 426, 428, 430, 432 (respectively). Storage devices 418, 420, 422, 424 may include: hard disk drives; tape drives; optical drives; RAID devices; random access memories (RAM); read-only memories (ROM), and all forms of flash memory storage devices. Examples of client electronic devices 426, 428, 430, 432 include personal computer 426, laptop computer 428, smartphone 430, laptop computer 432, a server (not shown), a data-enabled, and a dedicated network device (not shown). Client electronic devices 426, 428, 430, 432 each execute an operating system.

Users 434, 436, 438, 440 may access storage system 400 directly through network 402 or through secondary network 406. Further, storage system 400 may be connected to network 402 through secondary network 406, as illustrated with link line 442.

The various client electronic devices may be directly or indirectly coupled to network 402 (or network 406). For example, personal computer 426 is shown directly coupled to network 402 via a hardwired network connection. Further, laptop computer 432 is shown directly coupled to network 406 via a hardwired network connection. Laptop computer 428 is shown wirelessly coupled to network 402 via wireless communication channel 444 established between laptop computer 428 and wireless access point (e.g., WAP) 446, which is shown directly coupled to network 402. WAP 446 may be, for example, an IEEE 802.11a, 802.11b, 802.11g, 802.11n, Wi-Fi®, and/or Bluetooth® device that is capable of establishing a wireless communication channel 444 between laptop computer 428 and WAP 446. Smartphone 430 is shown wirelessly coupled to network 402 via wireless communication channel 448 established between smartphone 430 and cellular network/bridge 450, which is shown directly coupled to network 402.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing target content generated by processing source content using a generative artificial intelligence (AI) model, wherein the generative AI model performs a task using the source content to generate the target content;
extracting an ontological concept from the source content using a natural language processing (NLP) engine;
extracting an ontological concept from the target content using the NLP engine;
generating an ontological concept comparison score by comparing the ontological concept from the source content and the ontological concept from the target content based upon, at least in part, the task performed using the source content to generate the target content; and
identifying an issue in the target content based upon, the ontological concept comparison score and the task performed using the source content to generate the target content.

2. The computer-implemented method of claim 1, wherein generating the ontological concept comparison score includes:
obtaining an ontological graph including a plurality of ontological concepts; and
mapping the ontological concept from the source content and the ontological concept from the target content onto the ontological graph.

3. The computer-implemented method of claim 1, wherein generating the ontological concept comparison score includes:
determining a location of the ontological concept from the source content within the ontological graph;
determining a location of the ontological concept for the target content within the ontological graph; and
determining a distance and a relationship type between the ontological concept from source content and the ontological concept for the target content within the ontological graph.

4. The computer-implemented method of claim 1, wherein the ontological concept comparison score includes one or more of:
an equivalent relationship between the ontological concept from the source content and the ontological concept from the target content; and
a parent-child relationship between the ontological concept from the source content and the ontological concept from the target content.

5. The computer-implemented method of claim 1, wherein identifying the issue in the target content includes one or more of:
identifying a hallucination in the target content; and
identifying a missing ontological concept in the target content.

6. The computer-implemented method of claim 1, further comprising:
providing feedback to the generative AI model by processing a request including the source content, the target content, and the identified issue.

7. The computer-implemented method of claim 6, wherein providing feedback to the generative AI model includes one or more of:
processing a request including the source content, the target content, and the hallucination in the target content; and
processing a request including the source content, the target content, and the missing ontological concept in the target content.

8. A computing system comprising:
a memory; and
a processor configured to process target content generated by processing source content using a generative artificial intelligence (AI) model, wherein the generative AI model performs a task using the source content to generate the target content, to extract an ontological concept from the source content using a natural language processing (NLP) engine, to extract an ontological concept from the target content using the NLP engine, to generate an ontological graph including a plurality of ontological concepts using the NLP engine, to generate an ontological concept comparison score by comparing the ontological concept from the source content and the ontological concept from the target content based upon, at least in part, the ontological graph and the task performed using the source content to generate the target content, and to identify an issue in the target content based upon, the ontological concept comparison score and the task performed using the source content to generate the target content.

9. The computing system of claim 8, wherein generating the ontological concept comparison score includes:
obtaining an ontological graph including a plurality of ontological concepts; and
mapping the ontological concept from the source content and the ontological concept from the target content onto the ontological graph.

10. The computing system of claim 8, wherein generating the ontological concept comparison score includes:
determining a location of the ontological concept from the source content within the ontological graph;
determining a location of the ontological concept for the target content within the ontological graph; and
determining a distance and a relationship type between the ontological concept from source content and the ontological concept for the target content within the ontological graph.

11. The computing system of claim 8, wherein the ontological concept comparison score includes one or more of:
an equivalent relationship between the ontological concept from the source content and the ontological concept from the target content; and
a parent-child relationship between the ontological concept from the source content and the ontological concept from the target content.

12. The computing system of claim 8, wherein identifying the issue in the target content includes:
identifying a hallucination in the target content; and
identifying a missing ontological concept in the target content.

13. The computing system of claim 8, further comprising:
providing feedback to the generative AI model by processing a request including the source content, the target content, and the identified issue.

14. The computing system of claim 13, wherein providing feedback to the generative AI model includes one or more of:
processing a request including the source content, the target content, and the hallucination in the target content; and
processing a request including the source content, the target content, and the missing ontological concept in the target content.

15. A computer program product residing on a non-transitory computer readable medium having a plurality of instructions stored thereon which, when executed by a processor, cause the processor to perform operations comprising:
processing target content generated by processing source content using a generative artificial intelligence (AI) model, wherein the generative AI model performs a task using the source content to generate the target content;
extracting an ontological concept from the source content using a natural language processing (NLP) engine;
extracting an ontological concept from the target content using the NLP engine;
obtaining an ontological graph including a plurality of ontological concepts;
generating an ontological concept comparison score by comparing the ontological concept from the source content and the ontological concept from the target content based upon, at least in part, the ontological graph and the task performed using the source content to generate the target content;
identifying an issue in the target content based upon, the ontological concept comparison score and the task performed using the source content to generate the target content; and
providing feedback to the generative AI model by processing a request including the source content, the target content, and the identified issue.

16. The computer program product of claim 15, further comprising:
mapping the ontological concept from the source content and the ontological concept from the target content onto the ontological graph.

17. The computer program product of claim 15, wherein generating the ontological concept comparison score includes:
determining a location of the ontological concept from the source content within the ontological graph;
determining a location of the ontological concept for the target content within the ontological graph; and
determining a distance and a relationship type between the ontological concept from source content and the ontological concept for the target content within the ontological graph.

18. The computer program product of claim 15, wherein the ontological concept comparison score includes one or more of:
an equivalent relationship between the ontological concept from the source content and the ontological concept from the target content; and
a parent-child relationship between the ontological concept from the source content and the ontological concept from the target content.

19. The computer program product of claim 15, wherein identifying the issue in the target content includes:
identifying a hallucination in the target content; and
identifying a missing ontological concept in the target content.

20. The computer program product of claim 19, wherein providing feedback to the generative AI model includes one or more of:
processing a request including the source content, the target content, and the hallucination in the target content; and
processing a request including the source content, the target content, and the missing ontological concept in the target content.
